(19) United States
(12) Patent Application Publication
(10) Pub. No.: US 2025/0355274 A1
(43) Pub. Date: Nov. 20, 2025

(54) ELECTRONIC DEVICE ARM AND ASSEMBLY

(71) Applicant: Apple Inc., Cupertino, CA (US)

(72) Inventors: Ibuki Kamei, Santa Clara, CA (US); Josiah C. Frye, Kenmore, WA (US); Camille I. Henrot, San Francisco, CA (US); Alison B. Shutzberg, San Francisco, CA (US)

(21) Appl. No.: 18/962,446

(22) Filed: Nov. 27, 2024

Related U.S. Application Data
(60) Provisional application No. 63/648,145, filed on May 15, 2024.

(51) Int. Cl. G02C 5/14; G02C 11/00

(52) U.S. Cl. CPC G02C 5/143; G02C 11/10; G02C 2200/08

(57) ABSTRACT

An arm tip of a pair of glasses includes a housing, an exterior portion, a compliant portion, a battery, and an electrical connector. The housing includes an end portion positionable adjacent to a glasses arm. The exterior portion is disposed around the housing and includes a seamless surface. The compliant portion and the battery are disposed within the housing. The electrical connector is electrically coupled to the battery and is positioned opposite the end portion.

### CROSS-REFERENCE TO RELATED APPLICATION

This application claims the benefit of U.S. Provisional Patent Application No. 63/648, 145, filed 15 May 2024, and entitled “ELECTRONIC DEVICE ARM AND ASSEMBLY,” the entire disclosure of which is hereby incorporated by reference.

### FIELD

The described examples relate generally to electronic devices. More particularly, the present examples relate to electronic devices with a functional arm tip.

### BACKGROUND

Recent advances in portable computing have enabled head-mountable devices that provide augmented reality and virtual reality (AR/VR) experiences to users. Such head-mountable devices can include various components such as a display, a viewing frame, lenses optical components, a battery, motors, speakers, sensors, cameras, and other components. These components can operate together to provide an immersive user experience.

Powering such head-mountable devices has traditionally been a complex engineering task. Battery size and charge life, weight, and placement are some example design factors that each come with a variety of engineering challenges and can affect user experiences. As head-mountable devices become more mainstream in everyday use, and as power loads continue to increase, more viable battery implementations and assembly methods for head-mountable devices will be desired.

### SUMMARY

In at least one example, a glasses arm tip includes a housing, an exterior portion, a compliant portion, a battery, and an electrical connector. The housing can include an end portion positionable adjacent to a glasses arm. The exterior portion can be disposed around the housing and can include a seamless surface. The compliant portion and the battery can be disposed within the housing. The electrical connector can be electrically coupled to the battery and can be positioned opposite the end portion.

In one example of the arm tip, the housing includes a first housing portion and a second housing portion attached to the first housing portion. The exterior portion can include an overmolded portion at least partially encasing the first housing portion and the second housing portion.

In an additional example of the arm tip, the first housing portion and the second housing portion define an assembly aperture. At least one of the battery or the compliant portion can be configured to be inserted into the arm tip through the assembly aperture.

In an additional example of the arm tip, the overmolded portion is configured to be folded back to expose the assembly aperture.

In an additional example of the arm tip, each of the battery, the compliant portion, and the electrical connector are adhered to the first housing portion. The second housing portion can be adhered to the first housing portion.

In one example of the arm tip, the exterior portion includes a woven fabric.

In an additional example of the arm tip, the woven fabric includes a first woven material and a second woven material different from the first woven material.

In one example of the arm tip, the arm tip further includes a flex circuit electrically coupling the battery and the electrical connector.

In one example of the arm tip, the arm tip is removably attached to the glasses arm.

In at least one example, a pair of glasses includes a frame, a display lens disposed within the frame, an arm, and a head engagement portion. The arm can include a proximal portion configured to be coupled to the frame. The arm can include a distal portion opposite the proximal portion. The head engagement portion can be attachable to the distal portion. The head engagement portion can include a first shell portion including a first material, a second shell portion including a second material, the second shell portion being attachable to the first shell portion, a cover positioned over at least one of the first shell portion or the second shell portion, and a battery disposed between the first shell portion and the second shell portion.

In one example of the pair of glasses, the first shell portion is integrally connected to the arm.

In one example of the pair of glasses, the cover material includes a material different than the first material and the second material.

In one example of the pair of glasses, the pair of glasses further includes and electrical flex disposed between and electrically coupling the battery and the display lens.

In at least one example, a glasses arm includes a first arm portion, a second arm portion, and a fabric. The first arm portion can include an electrical connector, a local transmission source electrically coupled to the electrical connector, and an attachment feature electrically coupled to the local transmission source. The second arm portion can be configured to couple to a glasses frame and receive the attachment feature. The fabric can be disposed over the first arm portion.

In one example of the glasses arm, the local transmission source includes a processor configured to transmit data from the first arm portion and into the second arm portion via the attachment feature, and to the display.

In one example of the glasses arm, the fabric includes a first fabric region having a first material property and a second fabric region having a second material property different from the first material property.

In a further example of the glasses arm, the first material property corresponds to a first direction along the first arm portion, and the second material property corresponds to a second direction along the first arm portion. The second direction can be different than the first direction.

In a further example of the glasses arm, the first fabric region has a first fabric weave, and the second fabric region has a second fabric weave that is different than the first fabric weave.

In one example of the glasses arm, the fabric has an exterior surface devoid of seams.

In one example of the glasses arm, the first arm portion is adjustable between a first configuration and a second configuration that differs from the first configuration. The fabric can be fitted to the first arm portion. The fabric can be conformable to respective shapes of the first arm portion when in the first configuration and the second configuration.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a side view of a pair of glasses (also referred to as glasses or a head-mountable device), according to one example;

FIG. 2 illustrates a cut-away view of the pair of the pair of glasses, according to one example;

FIG. 3 illustrates an assembly process for a glasses arm tip, according to one example;

FIG. 4 illustrates another assembly process for a glasses arm tip, according to one example;

FIG. 5A illustrates yet another assembly process for a glasses arm tip, according to one example;

FIG. 5B illustrates a perspective view of an exterior portion of glasses arm tip including a woven fabric having a first woven material and a second woven material, according to one example;

FIG. 5C illustrates a perspective view of an exterior portion of a glasses arm tip including a woven fabric including a first fabric region and a second fabric region, according to one example;

FIG. 5D illustrates a top view of an exterior portion of a glasses arm tip including a woven fabric having a first fabric region and a second fabric region, according to one example;

FIG. 6 illustrates a top view of a portion of a glasses arm, according to one example;

FIG. 7A illustrates a perspective view of a portion of a glasses arm, according to one example;

FIG. 7B illustrates an exploded view of a portion of a glasses arm, according to one example;

FIG. 8A illustrates a perspective view of a head engagement portion of a glasses arm including an integrated shell portion, according to one example;

FIG. 8B illustrates an exploded view of the head engagement portion of FIG. 8A, according to one example;

FIG. 9A illustrates a perspective view of another arm tip of a glasses arm, according to one example;

FIG. 9B illustrates an exploded view of the glasses arm tip of FIG. 9A, according to one example;

FIG. 10A illustrates a perspective view of a portion of a glasses arm having a removable electrical connector for battery serviceability, according to one example;

FIG. 10B illustrates an exploded view of the portion of glasses arm in FIG. 10A, according to one example;

FIG. 11A illustrates a perspective view of a portion of a glasses arm having a removable battery assembly, according to one example;

FIG. 11B illustrates an exploded view of the portion of the glasses arm in FIG. 11A, according to one example; and

FIG. 12 illustrates a top, cross-sectional view of glass including an arm tip with a first support structure and a second support structure, according to one example.

### DETAILED DESCRIPTION

Reference will now be made in detail to representative examples illustrated in the accompanying drawings. It should be understood that the following descriptions are not intended to limit the examples to any one preferred example. To the contrary, it is intended to cover alternatives, modifications, and equivalents as can be included within the spirit and scope of the described examples as defined by the appended claims.

The following disclosure relates to head-mountable devices. In particular, the following disclosure relates to electronic glasses with functional arm tips. Examples of head-mountable electronic devices can include virtual reality or augmented reality devices that include an optical component. In the case of augmented reality devices, optical eyeglasses/glasses or frames can be worn on the head of a user such that optical windows, which can include transparent windows, lenses, or displays, can be positioned in front of the user's eyes. In another example, a virtual reality device can be worn on the head of a user such that a display screen is positioned in front of the user's eyes. The viewing frame can include a housing (e.g., a display housing or display frame) or other structural components supporting the optical components, for example lenses or display windows, or various electronic components.

Additionally, glasses as disclosed herein can include one or more electronic components used to operate the glasses. These electronic components can include any component used by the glasses to produce a virtual or augmented reality experience. For example, electronic components can include one or more projectors, waveguides, speakers, processors, batteries, circuitry components including wires and circuit boards, or any other electronic components used in the head-mountable device to deliver augmented or virtual reality visuals, sounds, and other outputs. The various electronic components can be disposed within one or more housing portions of the glasses. In some examples, the various electronic components in particular can be disposed within or attached to one or more of the display frame, the electronic component housing, or the glasses arm.

In at least one example, glasses of the present disclosure can include an arm tip with a housing having an end portion adjacent to a glasses arm. The arm tip can include a compliant portion, a battery, and an electrical connector, which can all be encased by an exterior portion in certain implementations.

Over time, batteries can malfunction, lose their charging capabilities, or become obsolete in comparison to newer battery technology. Some electronic glasses include batteries which are permanently enclosed within a portion of the head-mountable device for aesthetic purposes. Such a permanent battery configuration can render the batteries non-replaceable. Therefore, as the battery degrades over time, the user may need to replace the head-mountable device itself or else endure a poor user experience from shortened battery life, frequent charging, and/or long charge times.

The following disclosure relates to electronic glasses with functional arm tips. The functional arm tips can be easily serviced, interchanged or swapped for a different arm tip, removed, disassembled, and/or adjusted. A functional arm tip refers to an arm tip including hardware (e.g., battery, electronic components, sensors, processors, memory, etc.) that provides electric power and data communication to and from the arm tip and the electronic components of the glass frame and display lens.

For example, glasses with functional arm tips as disclosed herein can allow a user (and/or a manufacturer) to easily change or upgrade the battery without needing to update other portions of the glasses (or otherwise render the glasses obsolete). Additionally or alternatively, one or more functional arm tips of the present disclosure that have depleted their charge can be swapped out for other charged arm tips having a full charge (or higher charge level). In yet another example, one or more functional arm tips of the present disclosure can be swapped out for different colors, fabrics, materials, sizes, level of flexibility, amount of curvature or preload, etc. (e.g., blue-colored arm tips to go with a blue outfit, sport-fabric arm tips for a user's exercising session, or another arm tip for comfortable all-day use). Accordingly, the functional arm tips of the present disclosure can be removed, exchanged, and/or swapped (as desired).

In some examples, the arm tip can have a seamless surface in which the arm tip surface is visually devoid of seams (e.g., from an exterior perspective or outside view). The seamless surface can be formed in a variety of ways, including various novel methods of manufacturing or assembly. In some examples, a seamless surface is formed via an arm tip cover (or cover, which can refer to a variety of coatings, wraps, encasements, overmoldings, socks, shells, shaped housings, etc. forming an exterior surface of the arm tip). To illustrate, in some examples, the seamless surface is formed by overmolding an exterior portion of the arm tip, using a split-less arm tip, and/or by covering the arm tip with a woven fabric. A seamless surface of the arm tip can enhance the aesthetic appeal of the glasses. For example, the seamless arm tips of the present disclosure can give the electronic glasses a more familiar appearance of traditional glasses, rather than an electronic device. As another example, seamless arm tips can enhance (or at least prevent visually detracting from) a sleek profile of the glasses—whereas, visible line breaks or seams can be visually distracting and obvious indicators of electronic assembly.

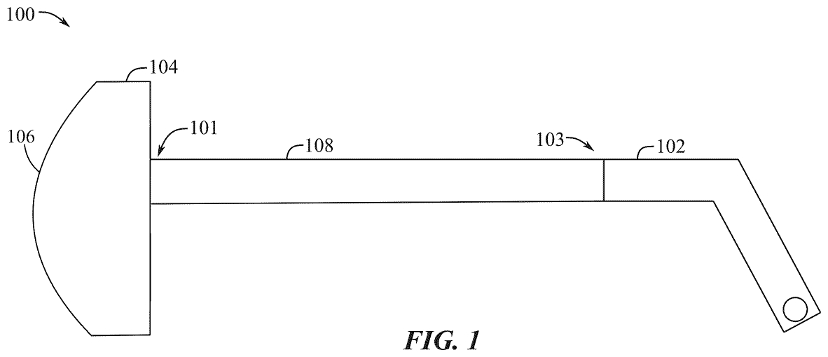

These and other examples are discussed below with reference to FIGS. 1-12. However, those skilled in the art will readily appreciate that the detailed description given herein with respect to these figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a side view of a pair of glasses 100 (also referred to as glasses or a head-mountable device) with a removable arm tip 102, according to one example. The pair of glasses 100 can be configured to be worn on a user's head to provide the user with a graphical display. The pair of glasses 100 can also be referred to as glasses, a head-mountable device, an augmented/virtual reality (A/V) device, or a wearable apparatus. The systems and methods can be used with any wearable apparatus, wearable electronic device, or any apparatus or system that can be physically attached to a user's body, but are particularly relevant to an electronic device worn on a user's head. The systems and methods described herein can also be applicable with any electronic device.

The pair of glasses 100 can include a frame 104, and a display lens 106 or other optical component disposed on or within the frame 104. Some examples of optical components can include one or more optical lenses or display screens in front of the eyes of the user. The display lens 106 can include one or more screens for presenting augmented reality visualizations, virtual reality visualizations (e.g., AR/VR visualizations), or other suitable visualizations. The display lens 106 can be configured to generate graphical data, such as videos, text, video games, etc. for the user. The display lens 106 can be part of an optical module, which can include sensors, cameras, light emitting diodes, an optical housing, a cover glass, sensitive optical elements, etc.

The pair of glasses 100 can include two arms 108. Each arm 108 can include a proximal portion 101 coupled to the frame 104 and a distal portion 103 opposite the proximal portion 101. The proximal portion 101 can be closer to a front of the user's head, while the distal portion 103 can be closer to a back of the user's head.

The arms 108 and the arm tips 102 can secure the pair of glasses 100 to the user's head. The arms 108 can be configured secure the pair of glasses 100 such that the display lens 106 is maintained in front of the user's eyes. For example, the arms 108 and the arm tips 102 can extend over the user's ears and rest on the user's ears. In some examples, the arms 108 can apply opposing pressures to the sides of the user's head to secure the pair of glasses 100 to the user's head.

The arm tip 102 (also referred to as a head engagement portion or arm portion) is attachable to the distal portion 103 of the arm 108. In other terms, the distal portion 103 can receive the arm tip 102. In some examples, the arm tip 102 can rest on the user's ears. Additionally or alternatively, the arm tip 102 can have a curvature that curves behind the user's ears to secure the pair of glasses 100 on the user's head. In some examples, the arm tip 102 can curve, bend, or flex (e.g., inward and toward the user head, outward and away from the user head, etc.) to accommodate different sizes of a user head, to engage more surface area of the user head, and/or to adjust an amount of arm tip bias or preload against the user head.

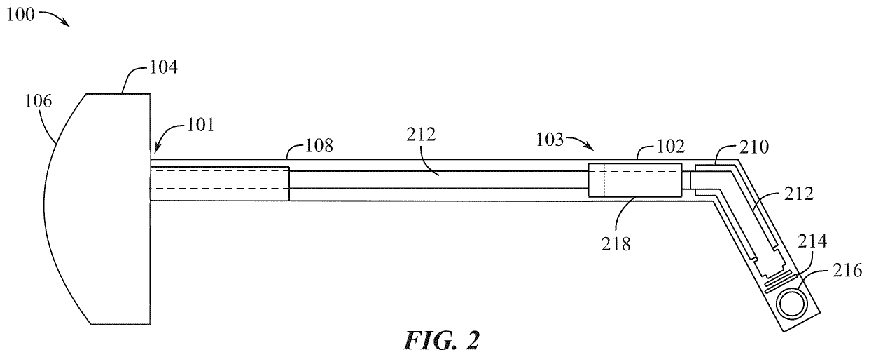

Any of the features, components, and/or parts, including the arrangements and configurations thereof shown in FIG. 1 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1. Additional details of glasses, particularly details for components positioned within the arm and/or arm tip, are described below in reference to FIG. 2.

FIG. 2 illustrates a cut-away view of the pair of the pair of glasses 100, according to one example. In this view, the outer portion of the arm housing and arm tip housing have been removed for illustrating internal contents of the arm 108 and the arm tip 102. The arm tip 102 (e.g., the head engagement portion) can be attachable to the distal portion 103 of the arm 108. In some examples, the arm tip 102 is removably attached (e.g., detachable and re-attachable) to the distal portion 103. In particular examples, the arm tip 102 can be swapped out for a different arm tip 102 (e.g., another arm tip having a different charge level, color, size, curvature, material, fabric, etc.).

As further described below, the arm tip 102 can include a variety of different implementations, including different housing (or shell) structures, different functional component arrangements (e.g., different positional configurations of a power supply, processor, memory, etc.), and different exterior surface designs (material, fabric, color, etc.). In some examples, the arm tip 102 can include a housing (e.g., a first shell portion and a second shell portion attachable to the first shell portion). The arm tip 102 includes a power supply 210 disposed in the housing (e.g., between the first shell portion and the second shell portion).

In these or other examples, the term “power supply” refers to any power source that supplies power to one or more components of the glasses 100 (e.g., to charge a battery or power a processor). For example, a power supply can include fuel cells, battery cells, generators, alternators, solar power converters, motion-based converters (e.g., that convert vibrations or oscillations into power), and the like. In particular implementations, a power supply can convert alternating current to direct current (or vice-versa) for charging or recharging components of the glasses 100. Some particular examples of a power supply can include a switched mode power supply, an uninterruptible power supply, an alternating current power supply, a direct current power supply, a regulated power supply, a programmable power supply, a computer power supply, and/or a linear power supply. In particular examples, the power supply 210 can be a rechargeable battery such as a lithium ion (Li-Ion) battery, a nickel-cadmium (NiCad) battery, a nickel-metal hydride (NiMH) battery, or other suitable type of rechargeable battery. The power supply 210 can provide power to the display lens 106 and/or various other electronic components of the glasses 100. The power supply 210 can be configured to provide electrical power through the arm 108 and to the display lens 106.

The pair of glasses 100 can also include an electrical flex 212. The electrical flex 212 can include or more discrete segments, or, in other examples a continuous portion that electrically couples two or more components (e.g., for the transmission of at least one of data and/or power). In some examples, the electrical flex 212 is disposed between and electrically couples the power supply 210 and the display lens 106. Additionally or alternatively, the electrical flex 212 can electrically couple the electrical connector 216 and the display lens 106. Further, in some examples, the electrical flex 212 can electrically couple the electrical connector 216 and the power supply 210 (e.g., via flex connector 214). In at least one example, the electrical flex 212 includes a hotbar or electrical connection at or adjacent to the compliant portion 218. In particular examples, the electrical flex 212 runs alongside (e.g., adjacent to) and/or through various components, such as the power supply 210, the compliant portion 218, etc. In these or other examples, the electrical flex 212 can be configured to bend or flex to conform to one or more curvatures of the arm tip 102. In at least one example, the curvature of one or more sections of the arm tip 102 can be manipulated to conform to the user's head shape and/or car position such that the pair of glasses 100 can be secured to the user's head. The electrical flex 212 can therefore accommodate the various movement or range of flex of the arm tip 102.

The arm tip 102 can include a flex connector 214 electrically coupling the power supply 210 and the electrical connector 216. The flex connector 214 can include electronic coupling components, such as pins and sockets to electrically couple the power supply 210 to the electrical connector 216 and/or the electrical flex 212. The electrical connector 216 can receive power via the electrical connector from an external source, such as an electrical outlet, an external battery, a conductive power port, a charging dock, a charging assembly or housing, etc. via one or more of a universal serial bus (USB) port, a micro-USB port, a USB-C port, an inductive charging element, a conductive element, or other suitable connector. In particular examples, the electrical connector 216 comprises a conductive material for physically contacting an external power supply. In other examples, the electrical connector 216 serves as a docking element to position the arm tip 102 in proximity to an inductive charging element.

As shown in FIG. 2, the arm tip 102 can include a compliant portion 218. The compliant portion 218 can be referred to as an ergonomic portion, a flexible portion, a bending portion, a torsional (twisting) portion, a connecting portion, etc. The compliant portion 218 can include springs, dampers, elastomers, biased tabs, cutouts, core outs, etc. that can allow the arm tip 102 to flex without detrimentally inducing movement to sensitive components and/or electrical connections. For example, the compliant portion 218 can allow the arm tip 102 to flex, such that the user can customize the fit of the pair of glasses 100 to their head shape, optimize or adjust fit, angle, comfort, etc. In certain implementations, at least a portion of the compliant portion 218 is coupleable to the arm 108. In at least one example, the compliant portion 218 serves as an arm interposer or flexible bridge to mechanically and/or electrically join the arm tip 102 and the arm 108. Thus, in some examples, the compliant portion 218 can help maintain a connection between the arm tip 102 and the arm 108 despite induced movement or user manipulation of the arm tip 102 relative to the arm 108.

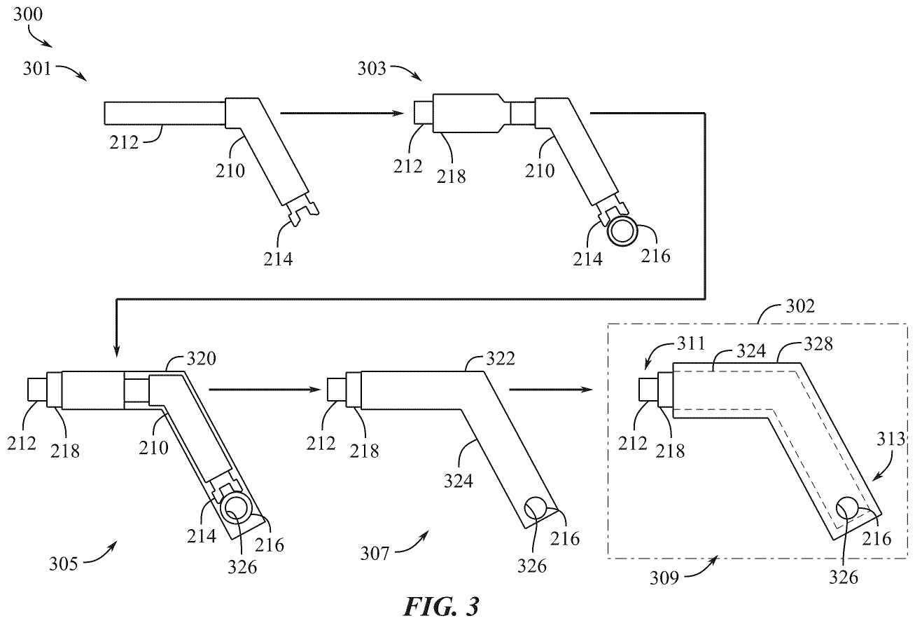

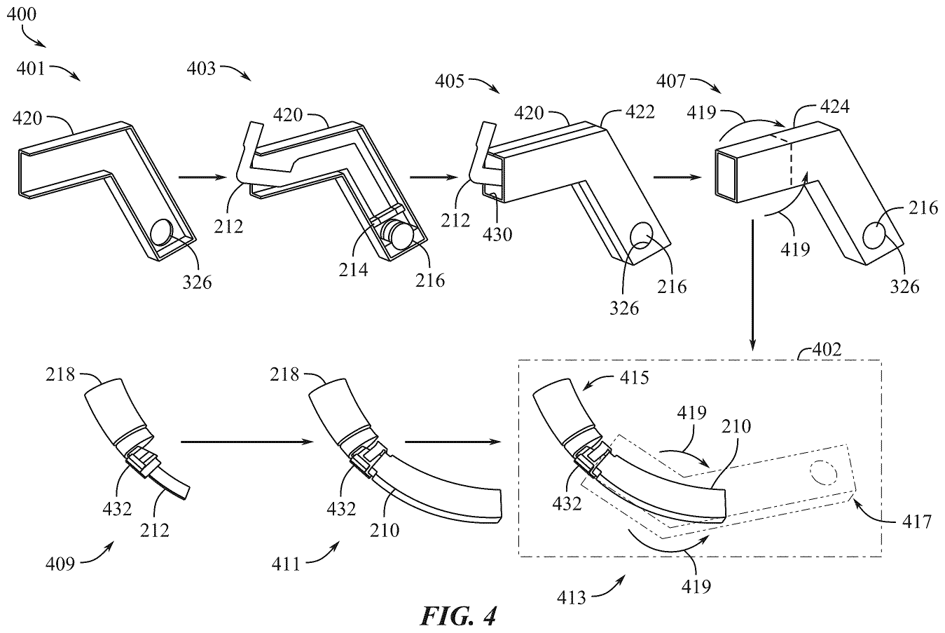

Any of the features, components, and/or parts, including the arrangements and configurations thereof shown in FIG. 2 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2. Assembly details of example glasses are described below in reference to FIGS. 3-4.

FIG. 3 illustrates an assembly process of an arm tip 302 of glasses 300, according to one example. Although additional or not all components of the glasses 300 and the arm tip 302 may be shown, the glasses 300 and the arm tip 302 can be the same as or similar to the glasses 100 and the arm tip 102 of FIGS. 1-2.

As depicted in step 301, the power supply 210 and the electrical flex 212 can be assembled. The electrical flex 212 can be terminated by the flex connector 214 at a distal end 313 of the arm tip 302. The distal end 313 of the arm tip 302 is opposite the proximal end 311 of the arm tip 302, which is positioned adjacent to and is receivable by the glasses arm 108 (not illustrated in FIG. 3).

As depicted in step 303, the compliant portion 218 can be assembled with the electrical flex 212 at the proximal end 311 of the arm tip 302. In some examples, the compliant portion 218 is positioned on top of and secured to the electrical flex 212. In other examples, the compliant portion 218 is placed around and secured to the electrical flex 212. In these or other examples, pressure sensitive adhesive, epoxy, or other securement methods can be used. The compliant portion 218 can be attachable and receivable by the distal portion 103 of the arm 108 (not illustrated in FIG. 3), as discussed above.

As depicted in step 305, the power supply 210, the electrical flex 212, and the compliant portion 218 can be assembled into and glued to a first shell portion 320 (e.g., a bottom shell or a bottom half of the arm tip housing).

As depicted in step 307, a second shell portion 322 (e.g., a top shell or top half of the arm tip housing) can be glued to the first shell portion 320. The first shell portion 320 and the second shell portion 322 form a shell 324 which at least partially encloses the power supply 210, the electrical flex 212, the flex connector 214, and the compliant portion 218. The first shell portion 320 the second shell portion 322 can include titanium (Ti) or other suitable material. For example, the first shell portion 320 and the second shell portion 322 can include various lightweight, yet strong materials (e.g., aluminum, graphite, carbon fiber, a polymer, etc.).

In some examples, a portion of the compliant portion 218 can extend past the proximal end 311 of the arm tip 302. In one example, the shell 324 includes an opening 326 at the distal end 313 of the arm tip, which exposes the electrical connector 216 to allow for electrical coupling to an external charging or data source. In one example, the shell 324 includes an end portion 315 positionable adjacent to the glasses arm 108 (as illustrated in FIGS. 1-2). The power supply 210, the electrical flex 212, the flex connector 214, and the compliant portion 218 can be adhered (e.g., using glue or other adhesive) to the first shell portion 320 and disposed within the shell 324. The electrical connector 216 can be positioned opposite the end portion 315.

As depicted in step 309, an exterior portion 328 can be formed over and disposed around the shell 324. The exterior portion 328 can be formed so as to define a seamless surface. For example, the exterior portion 328 can be formed by overmolding or coating over and around the shell 324. In particular examples, the exterior portion 328 includes a silicone (Si) overmolding. In other terms, the exterior portion 328 can include an overmolded portion at least partially encasing the first shell portion 320, the second shell portion 320, or a partial combination of the first shell portion 320 and the second shell portion 322.

Any of the features, components, and/or parts, including the arrangements and configurations thereof shown in FIG. 3 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3.

FIG. 4 illustrates another assembly process of an arm tip 402 of glasses 400, according to one example. In particular, FIG. 4 depicts an insertion-type assembly process. Although additional or not all components of the glasses 400 and the arm tip 402 can be shown, the glasses 400 and the arm tip 402 can be the same as or similar to the glasses 100-300 and the arm tip 102-302 of FIGS. 1-3.

As depicted in step 401, the arm tip 402 includes a first housing portion 420. As depicted in step 403, the electrical flex 212, the flex connector 214, and the electrical connector 216 can be installed and adhered to the first housing portion 420. The electrical connector 216 can be installed within the opening 326 positioned at a distal end 417 of the arm tip 402. The distal end 417 refers an end of the arm tip 402 that is furthest from a display of the glasses 400. The opening 326 exposes the electrical connector 216, allowing the power supply 210 to be charged via an external electrical power source.

As depicted in step 405, a second housing portion 422 can be welded or otherwise attached (e.g., snap fit, friction fit, bonded, adhered, etc.) to the first housing portion 420. The electrical flex 212, the flex connector 214, and the electrical connector 216 can be encompassed between a housing 424 including the first housing portion 420 and the second housing portion 422. The first housing portion 420 and the second housing portion 422 define an assembly aperture 430. The electrical flex 212 can extend from the electrical connector 216 out a proximal end 415 (opposite the distal end 417) of the housing 424.

As depicted in step 407, an overmolded portion 428 (e.g., an exterior portion or a cover) can be formed, over the housing 424. The overmolded portion 428 can be devoid of seams. In other terms, the overmolded portion 428 can have a smooth outer surface. The overmolded portion 428 can be a Si or other flexible or pliable material. The overmolded portion 428 can be folded back, as indicated by arrows 418 to expose the assembly aperture 430.

As depicted in step 409, the arm tip 402 can include the electrical flex 212 and the compliant portion 218 discussed above. The arm tip 402 can also include a connection 432 electrically coupled to the electrical flex 212.

As depicted in step 411, the arm tip 402 includes the power supply 210 electrically coupled to the electrical flex 212 via the connection 432. In some examples, the connection 432 can regulate the electrical coupling between the power supply 210 and other electronic components of the glasses 400. For example, the connection 432 can include circuitry to regulate electrical power output from the battery to electrical components of the glasses 400, such as the display lens 106 or other optical, audio, memory, and processing components. Additionally or alternatively, the connection 432 can regulate electrical power input from the electrical connector 216.

As depicted in step 413, the overmolded portion 428 can be peeled back or folded back to expose the assembly aperture 430 (shown in step 405). At least one of the power supply 210, the compliant portion 218, or the connection 432 can be inserted into the arm tip 402 through the assembly aperture 430. Subsequently, the overmolded portion 428 can be returned to its unfolded configuration.

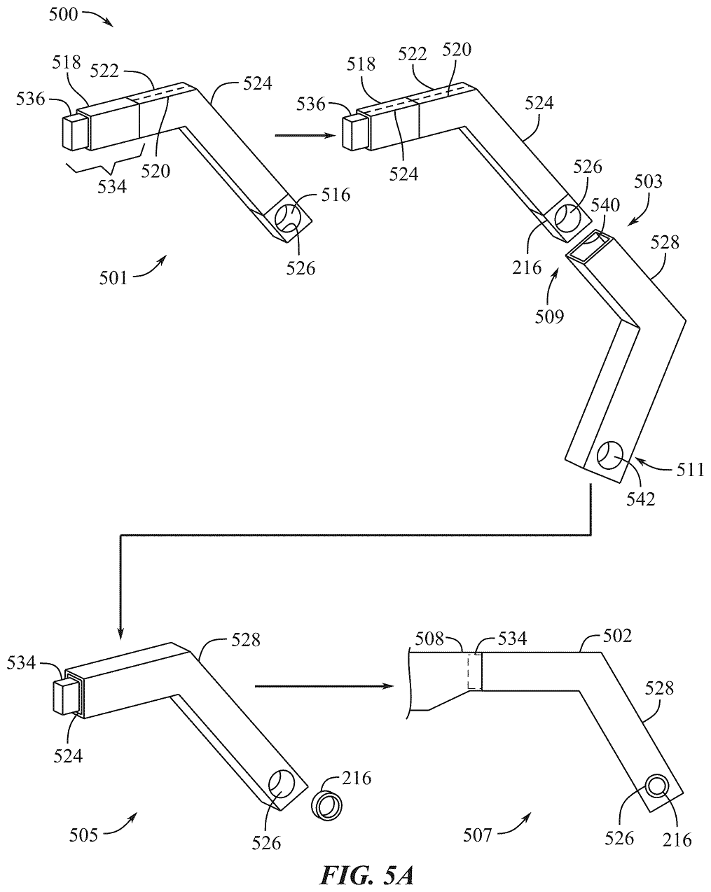

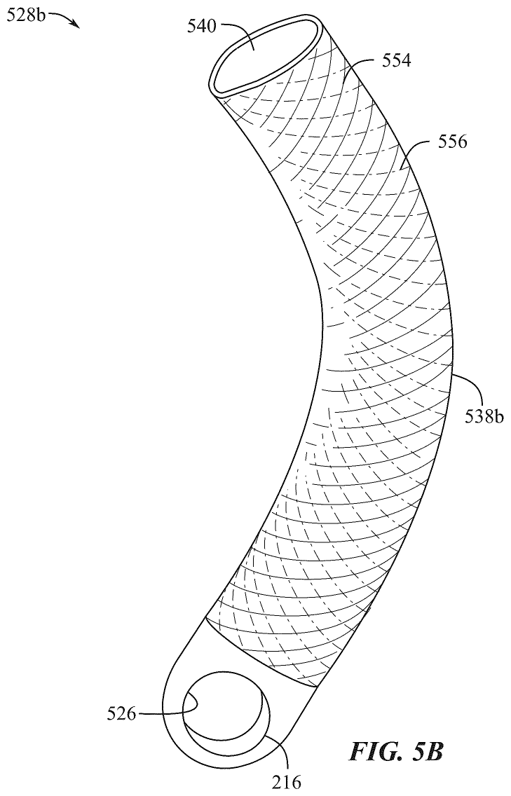

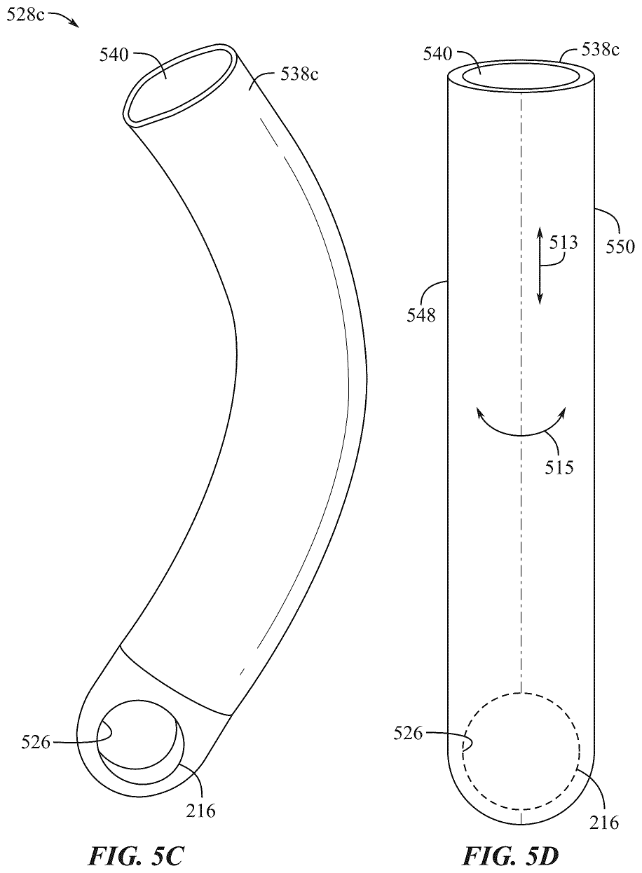

Any of the features, components, and/or parts, including the arrangements and configurations thereof shown in FIG. 4 can be included, cither alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4. Additional details of glasses arm tips with woven fabric exterior portions are described below in reference to FIGS. 5A-5D.

FIG. 5A illustrates a woven fabric-type assembly process of an arm tip 502 of glasses 500, according to one example. Although additional or not all components of the glasses 500 and the arm tip 502 may be shown, the glasses 500 and the arm tip 502 can be the same as or similar to the glasses 100-400 and the arm tip 102-402 of FIGS. 1-4 as noted by the same or similar reference numbers. For example, the glasses 500 include a first arm portion (e.g., the arm tip 502) and a second arm portion (e.g., the glasses arm 508).

As depicted in step 501, the arm tip 502 includes a housing 524 defined by a first housing portion 520 and a second housing portion 522 attached to the first housing portion 520. The arm tip 502 can include the electrical connector 516 and an attachment feature 534. The attachment feature 534 can include various connections or mating elements to electrically and/or mechanically join the arm tip 502 with a glasses arm. In one example, the attachment feature 534 can include a compliant portion 518 and an interposer 536. As used herein, an interposer refers to an electrical signal interface (e.g., for the transmission of data and/or power) between the arm tip 502 and the glasses arm 108.

As depicted in step 503, an exterior portion 528 can include a woven fabric 538 (or woven cover). The woven fabric 538 can be slid onto the housing 524 by an opening 540 at a proximal end 509 of the exterior portion 528. The fabric 538 can be disposed over the arm tip 502. A distal end 511 opposite the proximal end 509 of the woven fabric 538 can be seamlessly closed and can include an opening 542 to accommodate the electrical connector 216. For example, the fabric 538 can be woven such that an exterior surface of the fabric 538 can be devoid of seams, while an interior surface of the fabric 538 can include seams. The interior surface of the fabric 538 refers to a surface of the fabric 538 that is in contact with the housing 524, while the exterior surface of the fabric 538 refers to a surface of the fabric 538 that is partially in contact with the user's head.

A woven fabric 538 can include a flat knit fabric, a braided fabric, a birds-eye circular knit, a double jersey knit, or other suitable weaves/stitches. Such weaves allow for resolution of a curvature of a distal end of the woven fabric, with stitching that can follow or align with a curvature of the arm tip 502. The woven fabric 538 can be sufficiently thin so as to add minimal thickness to the arm tip 502. Additionally or alternatively, the woven fabric 538 can be sufficiently thick to protect the arm tip 502. For example, a thickness of the woven fabric can have a thickness within the following example thickness ranges (within about +/−10%): between 0.1 millimeters (mm)-1.0 mm, between 0.2 mm-0.9 mm, between 0.3 mm-0.8 mm, etc.

As depicted in step 505, the woven fabric 538 is disposed over the housing 524. The attachment feature 534 at least partially extends out of the proximal end 509 of the fabric 538. The attachment feature 534 can be removably received by the glasses arm 108.

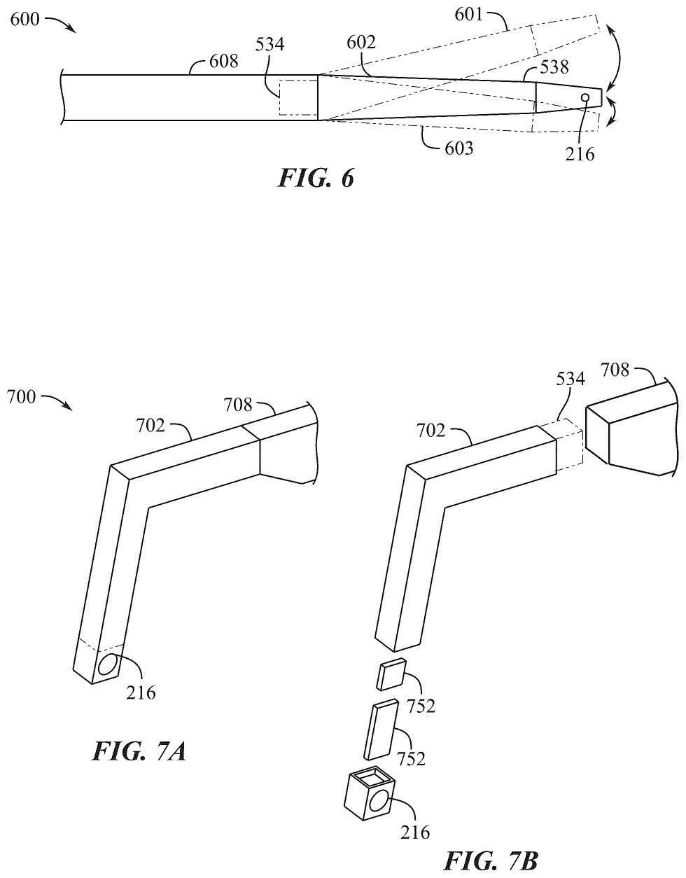

As depicted in step 507, the arm tip 502 is removably coupled to the glasses arm 108. The distal portion 103 of the arm 108 can receive the attachment feature 534 of the arm tip 502. As further described in reference to FIG. 6, the compliant portion 218 can allow an arm tip (e.g., any of the arm tips described herein) to be partially rotated or angled about the distal portion of the glasses arm 108. The interposer 536 can be an electrical and/or data interface between various components (such as the display lens 106, optical and audio components, memory, processors, transmitters, receivers, etc.) of the glasses arm 108 and various components (such as the power supply 210, the flex connector 214, the electrical connector 216, memory, processors, transmitters, receivers, etc.).

Any of the features, components, and/or parts, including the arrangements and configurations thereof shown in FIG. 5A can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5A. Additional details of glasses arm tips with woven fabric exterior portions are described below in reference to FIGS. 5B-5D.

FIG. 5B illustrates a perspective view of an exterior portion 528b including a woven fabric 538b including a first woven material 554 and a second woven material 556, according to one example. The first woven material 554 and the second woven material 556 can be interwoven to form the woven fabric 538. In at least one example, the second woven material 556 differs from the first woven material 554. In at least one example, the first woven material 554 has a first material property and the second woven material has a second material property. Although the second material property is described herein as being different than the first material property, in alternate examples, the second and the first material property can be the same.

A variety of different material properties are herein contemplated. In various examples, for instance, the first woven material 554 and the second woven material 556 have different thermal conductivities, electrical conductivities, stretch, Young's modulus, density, porousness, etc.

In some examples, the first woven material 554 can direct exterior heat away from the electronic components (the power supply 210, the flex connector 214, the electrical connector 216, the memory and process, etc.) while the second woven material 556 can shield internal heat (e.g., from the power supply 210) from reaching the surface. In this regard, the first woven material 544 and the second woven material 556 can act as insulators and/or heat reflectors.

In some examples, the first woven material 554 can allow the woven fabric 538b to be stretchy to receive the housing 524. Additionally or alternatively, the second woven material 556 can provide stiffness and structure to the woven fabric 538b.

In some examples, the first woven material 554 can be less dense and/or less porous (less tightly woven) than the second woven material 556 to provide airflow and comfort to the user's head. The second woven material 556 can provide stiffness and structure to the woven fabric 538b.

In some examples, the woven fabric 538b can include more than two woven materials that are mutually interwoven. For example, the woven fabric 538b can include a third woven material with a third material property. In additional examples, the woven fabric 538b can include a fourth woven material with a fourth material property, a fifth woven material with a fifth material property, etc.

FIGS. 5C-5D illustrate a perspective view and a side view, respectively, of an exterior portion 528c including a woven fabric 538c including a first fabric region 548 and a second fabric region 550, according to one example. Fabric regions can be defined or arranged in myriad different ways (e.g., side regions, top and bottom regions, forward (proximal) and backward (distal) regions, etc.). The first fabric region 548 and the second fabric region 550 can be woven seamlessly together to form the woven fabric 538c. In particular implementations, however, the first fabric region 548 can include a first fabric material, and the second fabric region 550 can include a second fabric material that differs from the first fabric material. In at least one example, the first fabric region 548 is in contact with the user's head and the second fabric region 550 is not in contact with the user's head.

In at least one example, the first fabric region 548 has a first material property and the second material region 550 has a second material property different from the first material property. Although the second material property is described herein as being different than the first material property, in alternate examples, the second and the first material property can be the same.

In at least one example, the first material property corresponds to a first direction 513 along the first arm portion (e.g., the arm tip 502), and the second material property corresponds to a second direction 515 along the first arm portion, the second direction 515 being different than the first direction 513. As depicted, the first direction 513 can be substantially longitudinal along the arm tip 502 while the second direction 515 can be substantially transverse to the arm tip 502.

In at least one example, the first fabric region 548 has a first fabric weave and the second fabric region 550 has a second fabric weave. As used herein, a weave refers to a style or manner in which a fabric is woven leading to particular fabric properties. For example, a weave can refer to a pattern or style in which the fabric is woven (e.g., plain weave, basket weave, twill weave, etc.), a tightness of the weave, a stitching direction, a material used, a thickness of fabric threads, etc.

In various examples, the first material region 548 and the second material region 550 have different thermal conductivities, electrical conductivities, stretch, Young's modulus, density, porousness, etc.

In some examples, the first material region 548 is more thermally conductive than the second material region 550 to direct heat away from the user's head.

In some examples, the first material region 548 can be less dense and/or less porous (less tightly woven) than the second material region 550 to provide airflow and softness to the user's head. The second material region 550 can provide stiffness and structure to the woven fabric 538c.

In some examples, the woven fabric 538c can include more than two material regions. For example, the woven fabric 538c can include a third material region with a third material property. In additional examples, the woven fabric 538c can include a fourth material region with a fourth material property, a fifth material region with a fifth material property, etc. Furthermore, each fabric region can encompass an appropriate section of the exterior portion (e.g., 10%, 20%, 40%, 50%, 70%, etc.).

Any of the features, components, and/or parts, including the arrangements and configurations thereof shown in FIGS. 5B-5D can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 5B-5D. Additional details of glasses arm tips with woven fabric exterior portions are described below in reference to FIG. 6.

FIG. 6 illustrates a side view of a portion of a pair of glasses 600, according to one example. The glasses 600 can include a first arm portion 602 (e.g., an arm tip) and a second arm portion 608 (e.g., a glasses arm). The first arm portion 602 includes the electrical connector 216, a local transmission source (described further in reference to FIGS. 7A-7B) electrically coupled to the electrical connector 216, and the attachment feature 534. An exterior portion of the first arm portion 602 includes a fabric 538. The second arm portion 608 can be coupled to the glasses frame 104 (not illustrated in FIG. 6). The second arm portion 608 can receive the attachment feature 534.

The first arm portion 602 is adjustable from the initial configuration between a first configuration 601 and a second configuration 603 that differs from the first configuration 601. The first arm portion 602 can be adjusted between the first configuration 601 and the second configuration 603 by being rotated about the attachment feature 534, which includes the compliant portion 218. The first configuration 601, in some examples, can range approximately (e.g., +/−10%) between 0°-20° while the second configuration 603 in some examples can range between 0°-10°. The angle of adjustment between the first configuration 601, the second configuration 603, and the initial configuration can be determined at least in part by the flexibility of the compliant portion discussed above.

The fabric 538 can be fitted to the first arm portion 602 and is conformable (e.g., malleable, moldable, bendable, flexible, etc.) to fit respective shapes of the first arm portion 602, when the first arm portion 602 is in the first configuration 601 and the second configuration 603. In some examples, different users can adjust the arm portion between the first configuration 601 and the second configuration 603 to fit their unique head shape and size, and facial profile. In some examples, a user can adjust the arm portion between the first configuration 601 and the second configuration 603 over time to adjust for facial fatigue.

As shown in FIG. 6, the arrows indicate maximum bending or rotation angles of the first arm portion 602 with respect to the second arm portion 608. In one example, the first arm portion 602 can be rotated in a first direction (e.g., toward a user head) by approximately 15° and in a second (e.g., splay) direction away from a user head by approximately 5°. In other examples, the first arm portion 602 can be rotated in the first direction by approximately 20° and in the second direction by approximately 10°.

Any of the features, components, and/or parts, including the arrangements and configurations thereof shown in FIG. 6 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6. Additional details of glasses arm tips with local transmission sources are described below in reference to FIGS. 7A-7B.

FIGS. 7A-7B illustrate a perspective view and an exploded view of a portion of a pair of glasses 700, according to one example. The pair of glasses 700 can be substantially similar to the pair of glasses 100 of FIG. 1. The pair of glasses 700 includes the frame 104 and the display lens 106 disposed with in the frame 104. The pair of glasses 700 includes a glasses arm made up of a first arm portion 702 and a second arm portion 708.

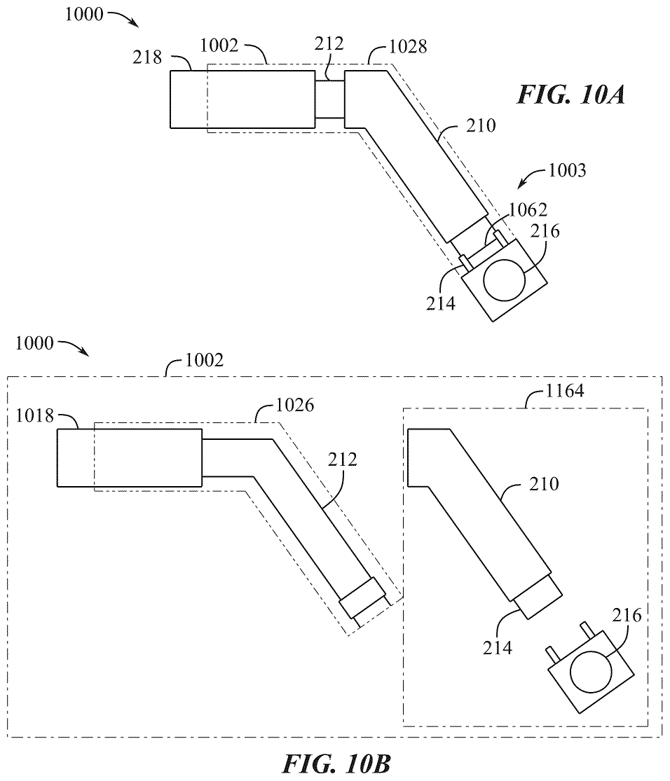

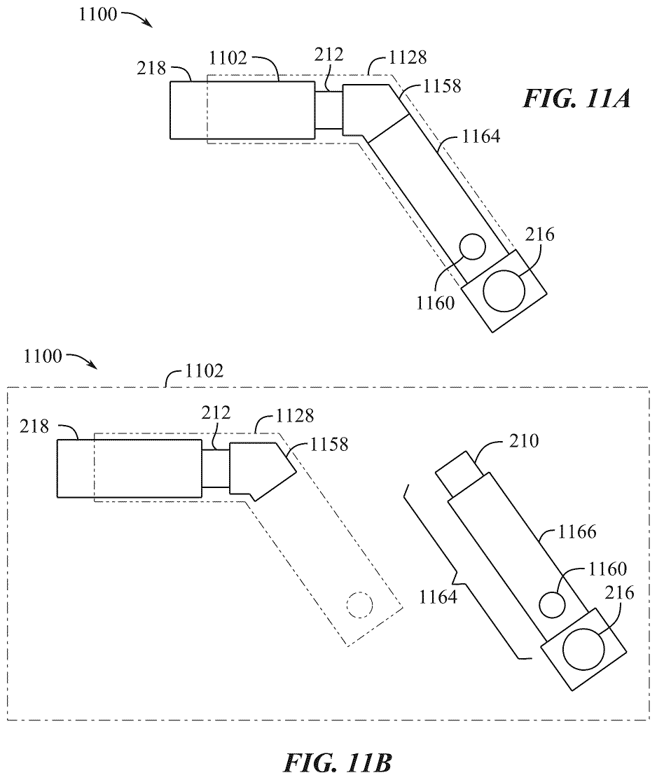

The first arm portion 702 can include the electrical connector 216, an attachment feature 534, and one or more local transmission sources 752 (FIG. 7B shows two local transmission sources 752, albeit more or fewer can be implemented). In the example of FIGS. 7A and 7B, the electrical connector 216 can be removed to conveniently access various components inside the first arm portion 702 (including the one or more local transmission sources 752 discussed below). FIGS. 10A-11B, as will be discussed later in this disclosure, provide some example implementations in which the electrical connector 216 is removed from the arm tip in particular to service a battery.

It will likewise be appreciated that the various components of the arm tip (i.e., the first arm portion 702) can be assembled through an assembly aperture exposed prior to insertion of the electrical connector 216. This assembly method can be advantageous, particularly in instances where the first arm portion 702 is not removable from the second arm portion 708. For example, the first arm portion 702 can be formed integral to the second arm portion 708, in which case internal components (e.g., the one or more local transmission sources 752) can be inserted through the assembly aperture prior to insertion of the electrical connector to close the assembly aperture.

The one or more local transmission sources 752 can be electrically coupled to the electrical connector 216. The attachment feature 534 can be electrically coupled to the one or more local transmission sources 752. As used herein, the term “local transmission source” can refer to a variety of different functional elements configured to transmit an element (e.g., electrical power, a data packet, computer-executable instructions, etc.). In some examples, the one or more local transmission sources 752 can include a processor to transmit data from the first arm portion 702 and into the second arm portion 708 via the attachment feature 534 (or the interposer 536 of the attachment feature 534), and to a display, such as the display lens 106. In some examples, the one or more local transmission sources 752 can include the power supply 210, and the processor (the other depicted local transmission source) can cause the power supply 210 to transfer power to the display lens 106. In some examples, the one or more local transmission sources 752 can include a memory device storing instructions that, when executed by the processor, cause the processor to perform one or more acts or steps. In some examples, the processor, in response to executing the computer-executable instructions (provided by or retrieved from) the memory device, can: i) transmit data from the first arm portion 702 and into the second arm portion 708 (and onto the display lens 106) via the attachment feature 534, and/or ii) transmit a signal to the power supply 210 that, in turn, causes the power supply 210 to relay (or stop relaying) power to the display lens 106 or other component of the glasses.

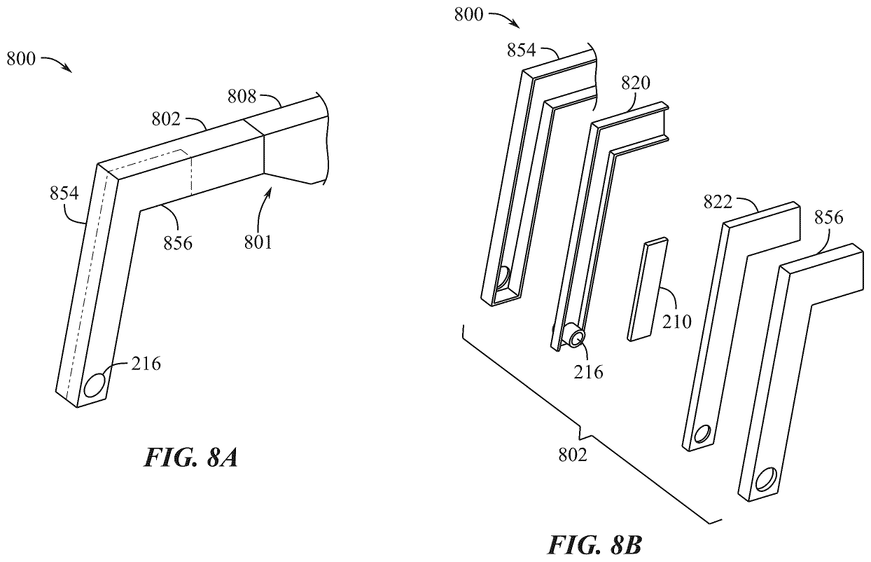

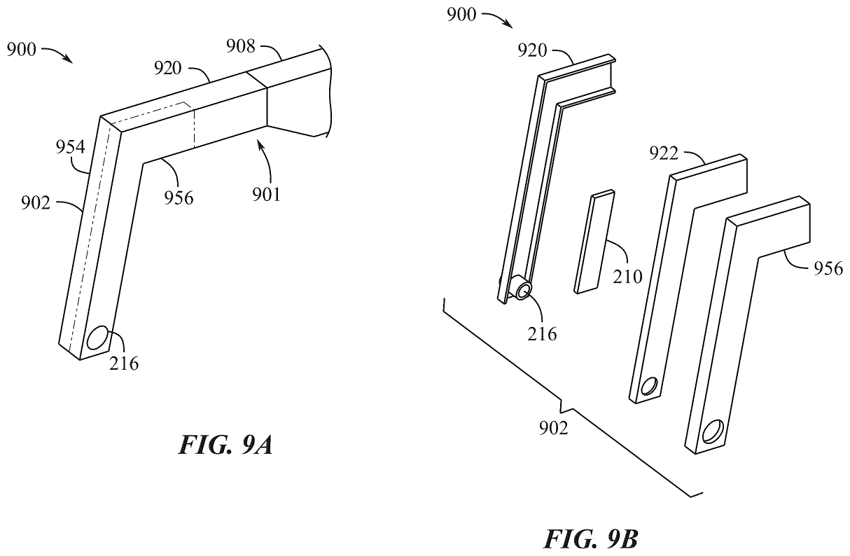

Any of the features, components, and/or parts, including the arrangements and configurations thereof shown in FIGS. 7A-7B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 7A-7B. Additional details of glasses arm tips with partially integrated exterior shells are described below in reference to FIGS. 8A-8B and 9A-9B. Partially integrated shells can, in some examples, hide any seams or splits in the arm tip from an exterior view while a user is wearing the glasses. Additionally or alternatively, partially integrated shells can allow for arm tip customization.

FIGS. 8A-8B illustrate a perspective view and an exploded view, respectively, of a head engagement portion 802 of a pair of glasses 800 including an integrated shell portion 820, according to one example. The pair of glasses 800 includes the frame 104 and a display lens 106 (as illustrated in at least FIG. 1) disposed within the frame. The pair of glasses 800 includes an arm 808 with a proximal portion configured to be coupled to the frame 104, and a distal portion 801 opposite the proximal portion.

The pair of glasses 800 includes a head engagement portion 802 attachable to the distal portion 801. The head engagement portion 802 can be similar to an arm tip which can be flexible and include curves/bends to secure the pair of glasses 800 to the user's head. The head engagement portion 802 can be at least partially encased by a cover having a cover material, such as silicone or similar material that provides friction against the user's head to secure the pair of glasses 800 to the user's head.

The head engagement portion 802 includes a first shell portion 854 and a second shell portion 856. The first shell portion 854 is integrally connected to the arm 808. The second shell portion 856 (e.g., a cover shell or cover) is attachable to the first shell portion 854. The first shell portion 854 and the second shell portion 856 can encompass (or otherwise be positioned over or on top of) a housing including a first housing shell portion 820 and a second housing shell portion 822. In at least one example, the first shell portion 854 and the second shell portion 856 include a same material, such as silicone. Alternatively, the first shell portion 854 and the second shell portion 856 can include differing materials (e.g., for a different head-contact (inner-facing) surface or a different outer-facing aesthetic surface). Further, the first housing shell portion 820 and the second housing shell portion 822 can include titanium or other suitable metal to provide structure to the head engagement portion 802.

In at least one example, the first housing shell portion 820 and the second housing shell portion 822 can be mutually adhered, and can house electronic components such as the power supply 210 (or any other local transmission source), the electrical flex, the flex circuit, and the electrical connector. The first shell portion 854 and the second shell portion 856 can at least partially house the first housing shell portion 820 and the second housing shell portion 822 as well as a compliant portion that is receivable by the arm 808.

Any of the features, components, and/or parts, including the arrangements and configurations thereof shown in FIGS. 8A-8B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 8A-8B. Additional details of glasses arm tips with partially integrated exterior shells are described below in reference to FIGS. 9A-9B.

FIGS. 9A-9B illustrate a perspective view and an exploded view of head engagement portion 902 of a pair of glasses 900 including a housing shell portion 920, according to one example. The pair of glasses 900 includes the frame 104 and a display lens 106 (as illustrated in at least FIG. 1) disposed within the frame. The pair of glasses 900 includes an arm 908 with a proximal portion configured to be coupled to the frame 104, and a distal portion opposite the proximal portion 901.

The glasses 900 are substantially similar to the glasses 800 except that the first housing shell portion 920 is integrally connected to the arm 908, thereby serving as an exterior portion. Additionally, the glasses 900 lack an outer cover shell portion. In other terms, the first housing shell portion 920 forms a housing portion with the second housing shell portion 922 and a cover shell 956.

The pair of glasses 900 includes a head engagement portion 902 attachable to the distal portion 901. The head engagement portion 902 can be similar to an arm tip which can be flexible and include curves/bends to secure the pair of glasses 900 to the user's head. The head engagement portion 902 can be at least partially encased by metal and silicone, which provides friction against the user's head to secure the pair of glasses 900.

The head engagement portion 902 includes a first housing shell portion 920 integrally connected to the arm 908. The head engagement portion 902 also includes the cover shell 956 and a second housing shell portion 922 attachable to the first housing shell portion 920. In at least one example, the cover shell 956 includes silicone. Further, the first housing shell portion 920 and the second housing shell portion 922 include titanium or other suitable metal to provide structure to the head engagement portion 902. Although described herein as having a first housing shell portion 920 which is integrally connected to the arm 908, in alternate examples, a pair of glasses can lack the first housing portion and instead include a second housing portion which is integrally connected to the arm 908.

The first housing shell portion 920, the second housing shell portion 922, and the cover shell 956 can be mutually adhered, and can house electronic such as the power supply 210, the electrical flex, the flex circuit, and the electrical connector. The first housing shell portion 920, the second housing shell portion 922, and the cover shell 956 can at least partially enclose a compliant portion that is receivable by the arm 908.

Any of the features, components, and/or parts, including the arrangements and configurations thereof shown in FIGS. 9A-9B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 9A-9B. Additional details of glasses with replaceable arm tips and batteries are described below in reference to FIGS. 10A-10B.

FIGS. 10A-10B illustrate a perspective view and an exploded view, respectively, of a portion of a pair of glasses 1000 with a removable electrical connector 216 for battery serviceability (e.g., replacement, adjustment, etc.), according to one example. The pair of glasses 1000 can be substantially similar to the pair of glasses 100 of FIG. 1. The pair of glasses 1000 includes the frame 104 and the display lens 106 (neither are shown in FIGS. 10A-10B) disposed within the frame 104. The pair of glasses 1000 includes a glasses arm including a first arm portion 1002 and a second arm portion (not illustrated). The second arm portion can be coupled to the frame 104 at a proximal end and can receive the first arm portion 1002 at a distal end opposite the proximal end.

The first arm portion 1002 includes the power supply 210, the electrical flex 212, the electrical connector 216, and a flex connector 214 electrically coupling the power supply 210 and the electrical connector 216. In at least one example, the electrical connector 216 can be removable from the flex connector 214. The electrical connector 216 can be removed by un-adhering an adhesive seal 1062 and/or by proper manipulation or application of controlled force. The adhesive seal 1062 can be a re-workable adhesive seal which is reusable for each battery replacement. Following removal of the electrical connector 216, the power supply 210 and the flex connector 214 can be removed from the exterior portion 1028. The power supply 210 and the flex connector 214 can be removed through the distal end 1003 of the first arm portion 1002 from where the electrical connector 216 is removable.

The power supply 210 and the flex connector 214 can be removed from the exterior portion 1028 by being slid out from within the arm tip. Once removed, the power supply 210 can be serviced (e.g., replaced by a new or refurbished battery). Subsequent to installation of a battery, the electrical connector 216 can be reattached to the first arm portion 1002 by the adhesive seal 1062. In some examples, battery replacement can be done by the user, the manufacturer, and/or a third party.

Any of the features, components, and/or parts, including the arrangements and configurations thereof shown in FIGS. 10A-10B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 10A-10B. Additional details of glasses with replaceable arm tips and batteries are described below in reference to FIGS. 11A-11B.

FIGS. 11A-11B illustrate a perspective view and an exploded view respectively, of a portion of a pair of glasses 1100 with a removable battery assembly for battery serviceability, according to one example. The pair of glasses 1100 can be substantially similar to the pair of glasses 100 of FIG. 1. The pair of glasses 1100 includes the frame 104 and the display lens 106 (neither are shown in FIGS. 11A-11B) disposed within the frame 104. The pair of glasses 1100 includes a glasses arm including a first arm portion 1002 and a second arm portion (not illustrated). The second arm portion can be coupled to the frame 104 at a proximal end and can receive the first arm portion 1002 at a distal end opposite the proximal end.

The first arm portion 1102 includes the power supply 210, the electrical flex 212, the electrical connector 216, and a flex connector 214 electrically coupling the power supply 210 and the electrical connector 216, and a button assembly 1160. A battery assembly 1164 of the first arm portion 1102 can include the power supply 210, a sleeve 1166, and a button 1168 of the button assembly 1160. When depressed, the button 1168 can be released from a button opening 1170 (e.g., a hole, opening, or cutout) on an exterior portion 1128 of the first arm portion 1102.

The button assembly 1160 can be removable from the exterior portion 1128 by releasing the button 1168 from the button opening 1170 to allow the power supply 210 to be replaced or serviced. Unlike the first arm portion 1002 of FIG. 10, the power supply 210 of the first arm portion 1102 can be replaceable without the need for an adhesive seal. However, in some examples, a first arm portion can include both a button assembly and an adhesive seal for battery replicability.

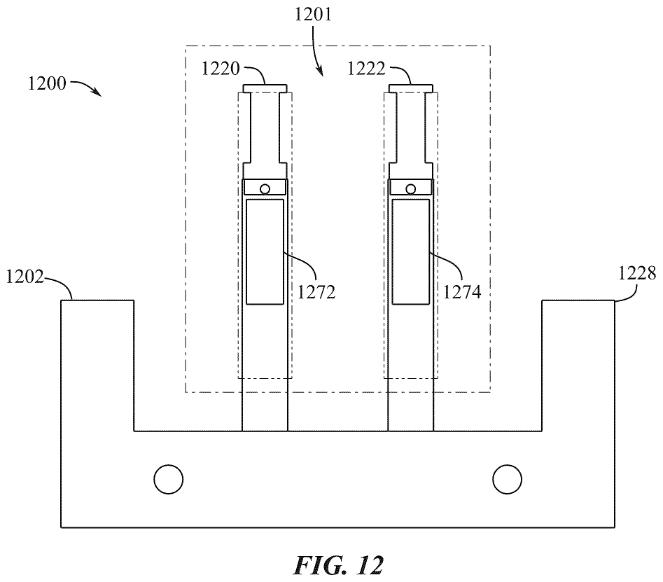

Any of the features, components, and/or parts, including the arrangements and configurations thereof shown in FIGS. 11A-11B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIGS. 11A-11B. Additional details of arm tip internal structures are described below in reference to FIG. 12.

FIG. 12 illustrates a cross-sectional view of an arm tip 1202 of glasses 1200 with a first support structure 1272 and a second support structure 1274, according to one example. In particular, the cross-sectional view of the arm tip 1202 is seen from a back of the glasses 1200 toward a front of the glasses 1200. The arm tip 1202 can include a first housing portion 1220, a second housing portion 1222, and an exterior portion 1228 (which is only partially shown) encompassing the first housing portion 1220 and the second housing portion 1222. Components such as the battery, the electrical flex, the flex circuit, the electrical connector, and the compliant portion can be at least partially encased by the first housing portion 1220 and the second housing portion 1222 in the region indicated by arrow 1201.

In at least one example, the first support structure 1272 can be disposed within or along the first housing portion 1220 and the second support structure 1274 can be disposed within or along the second housing portion 1222. In some examples, the first support structure 1272 and the second support structure 1274 can protect the battery from being squeezed or crushed during an overmold process of the exterior portion 1228. In some examples, the first support structure 1272 and the second support structure 1274 provide longitudinal support (e.g., along a longitudinal axis (running from the display lens to the arm tip 1202) to minimize bending of the arm tip 1202.

Any of the features, components, and/or parts, including the arrangements and configurations thereof shown in FIG. 12 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 12.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, X (formerly TWITTER®) ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates examples in which users selectively step the use of, or access to, personal information data. That is, the present disclosure contemplates that hardware and/or software elements can be provided to prevent or step access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed examples, the present disclosure also contemplates that the various examples can also be implemented without the need for accessing such personal information data. That is, the various examples of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not intended to be exhaustive or to limit the examples to the precise forms disclosed. It will be apparent to one of ordinary skill in the art that many modifications and variations are possible in view of the above teachings.

What is claimed is:

1. A glasses arm tip, comprising:
a housing including an end portion positionable adjacent to a glasses arm;
an exterior portion disposed around the housing, the exterior portion comprising a seamless surface;
a compliant portion disposed within the housing;
a battery disposed within the housing; and
an electrical connector electrically coupled to the battery, the electrical connector positioned opposite the end portion.

2. The arm tip of claim 1, wherein:
the housing comprises a first housing portion and a second housing portion attached to the first housing portion; and
the exterior portion comprises an overmolded portion at least partially encasing the first housing portion and the second housing portion.

3. The arm tip of claim 2, wherein:
the first housing portion and the second housing portion define an assembly aperture; and
at least one of the battery or the compliant portion is configured to be inserted into the arm tip through the assembly aperture.

4. The arm tip of claim 3, wherein the overmolded portion is configured to be folded back to expose the assembly aperture.

5. The arm tip of claim 2, wherein:
each of the battery, the compliant portion, and the electrical connector are adhered to the first housing portion; and
the second housing portion is adhered to the first housing portion.

6. The arm tip of claim 1, wherein the exterior portion comprises a woven fabric.

7. The arm tip of claim 6, wherein the woven fabric comprises:
a first woven material; and
a second woven material different from the first woven material.

8. The arm tip of claim 1, further comprising a flex circuit electrically coupling the battery and the electrical connector.

9. The arm tip of claim 1, wherein the arm tip is removably attached to the glasses arm.

10. A pair of glasses, comprising:
a frame;
a display lens disposed within the frame;
an arm comprising a proximal portion configured to be coupled to the frame and a distal portion opposite the proximal portion; and
a head engagement portion attachable to the distal portion, the head engagement portion comprising:
a first shell portion comprising a first material;
a second shell portion comprising a second material, the second shell portion attachable to the first shell portion;
a cover positioned over at least one of the first shell portion or the second shell portion; and
a battery disposed between the first shell portion and the second shell portion.

11. The pair of glasses of claim 10, wherein the first shell portion is integrally connected to the arm.

12. The pair of glasses of claim 10, wherein the cover comprises a material different than the first material and the second material.

13. The pair of glasses of claim 10, further comprising an electrical flex disposed between and electrically coupling the battery and the display lens.

14. A glasses arm, comprising:
a first arm portion including:
an electrical connector;
a local transmission source electrically coupled to the electrical connector; and
an attachment feature electrically coupled to the local transmission source;
a second arm portion configured to be coupled to a glasses frame, the second arm portion configured to receive the attachment feature; and
a fabric disposed over the first arm portion.

15. The glasses arm of claim 14, wherein the local transmission source comprises a processor configured to transmit data from the first arm portion and into the second arm portion via the attachment feature, and to a display.

16. The glasses arm of claim 14, wherein the fabric comprises a first fabric region having a first material property and a second fabric region having a second material property different from the first material property.

17. The glasses arm of claim 16, wherein the first material property corresponds to a first direction along the first arm portion, and the second material property corresponds to a second direction along the first arm portion, the second direction being different than the first direction.

18. The glasses arm of claim 16, wherein the first fabric region comprises a first fabric weave and the second fabric region comprises a second fabric weave different than the first fabric weave.

19. The glasses arm of claim 14, wherein the fabric comprises an exterior surface devoid of seams.

20. The glasses arm of claim 14, wherein:
the first arm portion is adjustable between a first configuration and a second configuration that differs from the first configuration; and
the fabric is fitted to the first arm portion, the fabric being conformable to respective shapes of the first arm portion when in the first configuration and the second configuration.
